(19) United States
(12) Patent Application Publication
(10) Pub. No.: US 2012/0319342 A1
(43) Pub. Date: Dec. 20, 2012

(54) Pipe Clamp

(76) Inventor: Christopher Charles Macey, Frome (GB)

(21) Appl. No.: 13/580,705

(22) PCT Filed: Feb. 23, 2010
(86) PCT No.: PCT/GB2010/000321

§ 371 Date: Aug. 23, 2012

(51) Int. Cl. B25B 1/24

(52) U.S. Cl. 269/257

(57) ABSTRACT

A pipe clamp comprising of an outer top casing (1) and bottom casing (2); being held together as one piece by a hinges (3) & (5) and pins (7). Inside, the casing consists of two carriages, the bottom carriage (4) being stationary whilst the top carriage (6) moves with the use of nylon runners. These runners (10, 11) run in a parallel motion to each other whilst also moving in an angled downwards motion, allowing the top and bottom carriage to also run parallel to each other and therefore forming a clamp when a pipe is placed inside and pulled. The clamp will grip a pipe size of 125 mm, however the clamp comes supplied with attachments (8) to enable it to be used with 63 mm, 75 mm, 90 mm and 110 mm.

### FIELD OF THE INVENTION

The invention relates to a pipe clamp to be used initially within the utilities industry to help in pushing various size pipes into the ground or inside existing pipes.

### SUMMARY OF THE INVENTION

According to the invention, there is provided a pipe clamp comprising a hinged casing unit which houses a carriage system, which consists of a stationary bottom carriage and a moving top carriage. The invention works by placing the pipe inside the clamp, which will then hold the pipe in place parallel to the ground or existing pipe, enabling the pipe to be pushed through the ground at a far easier rate than alternative options currently on the market. This is a one man operation, without the need to be exposed to dangerous machinery making it very safe. This aspect is favourable towards the HSE directive.

### BRIEF DESCRIPTION OF THE DRAWINGS

An embodiment of the present invention is described below with reference to the accompanying drawings, in which:

FIG. 1 is a perspective view of an external casing for a pipe clamp that is an embodiment of the invention;

FIG. 2 is a partial perspective view of the pipe clamp of FIG. 1 and an insert therefor; and

FIG. 3 is a exploded perspective view of the carriage system for the pipe clamp of FIG. 1.

### DETAILED DESCRIPTION; FURTHER OPTIONS AND PREFERENCES

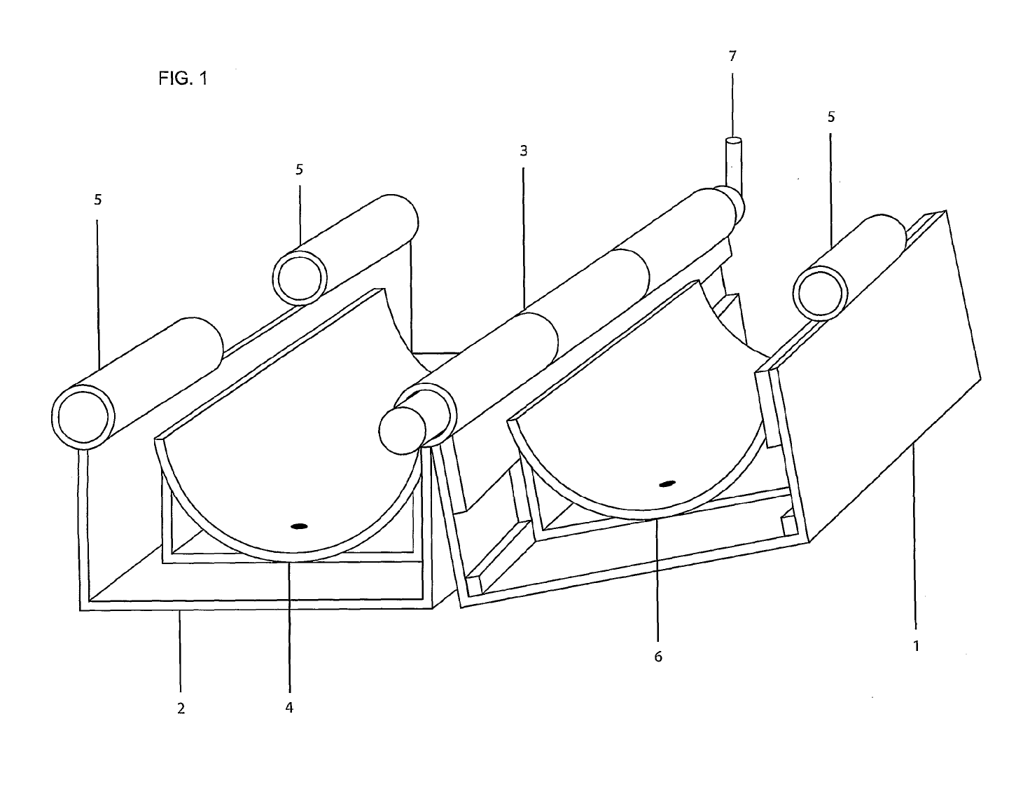

A pipe clamp that is an embodiment of the invention (and referred to below as Ace's PC1) comprises of two main carriages which can be independent of each other, enabling the user to fit with the correct size attachment and place into position. FIG. 1 shows the two main carriages as they are before any attachments are inserted. The outer shell of the clamp is made of mild steel with the top casing 1 being able to be securely attached to the bottom casing 2 when a pin 7 is inserted into the fashioned tubes 3, effectively forming a hinge. The top casing differs from the bottom by having a moveable inner carriage 6; where as the bottom casing 2 has a stationary fixed inner carriage 4. By inserting the bottom casing 2 into place, a pipe can then be laid onto the shaped bottom inner carriage 4 and when the top casing 1 is then closed over the top of the bottom casing, a pin 7 can then be placed in the fashioned tubes 5 to make a secure encasement around the pipe. Without any attachments inserted the clamp will grip a 125 mm pipe. This same clamping system can also be used to manufacture an adapted clamp on a larger scale to enable use with pipes upwards of size 125 mm.

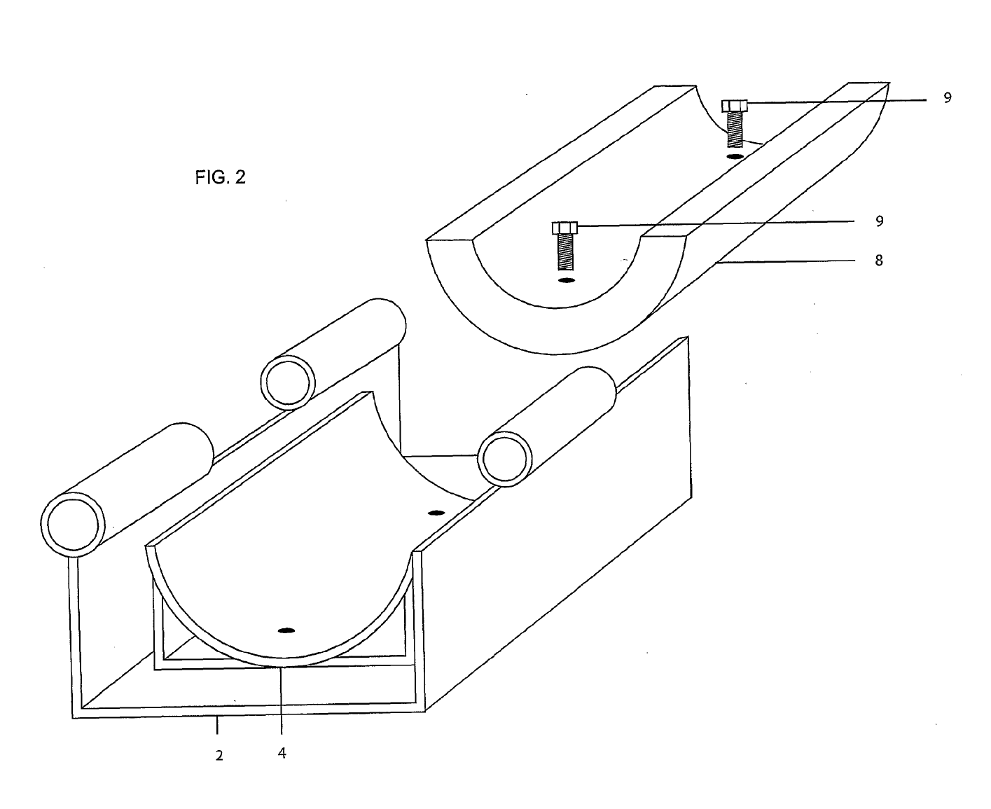

The clamp comes with a supply of attachments that can be easily inserted into the outer shells 1 & 2 to facilitate the use of the clamp with alternative size pipes as shown in FIG. 2. The attachments supplied can enable the clamp to grip pipe sizes 55 mm, 63 mm, 75 mm, 90 mm and 110 mm as well as 125 mm without any attachment inserted. FIG. 2 shows the use of an attachment 8 being inserted into the bottom inner carriage 4 and being securely fixed into place by screws 9. A matching sized attachment is again used for the top casing in exactly the same manner. The attachments are made from natural nylon and the thickness of each one determines the size of pipe in which the clamp will be able to grip. They are fixed into place on each inner carriage by 2×8 mm cap head screws which sit into the attachment when fully in place leaving a flush upper side for the pipe to lie against. Supplied with the clamp are also the necessary tools to fix these screws into place.

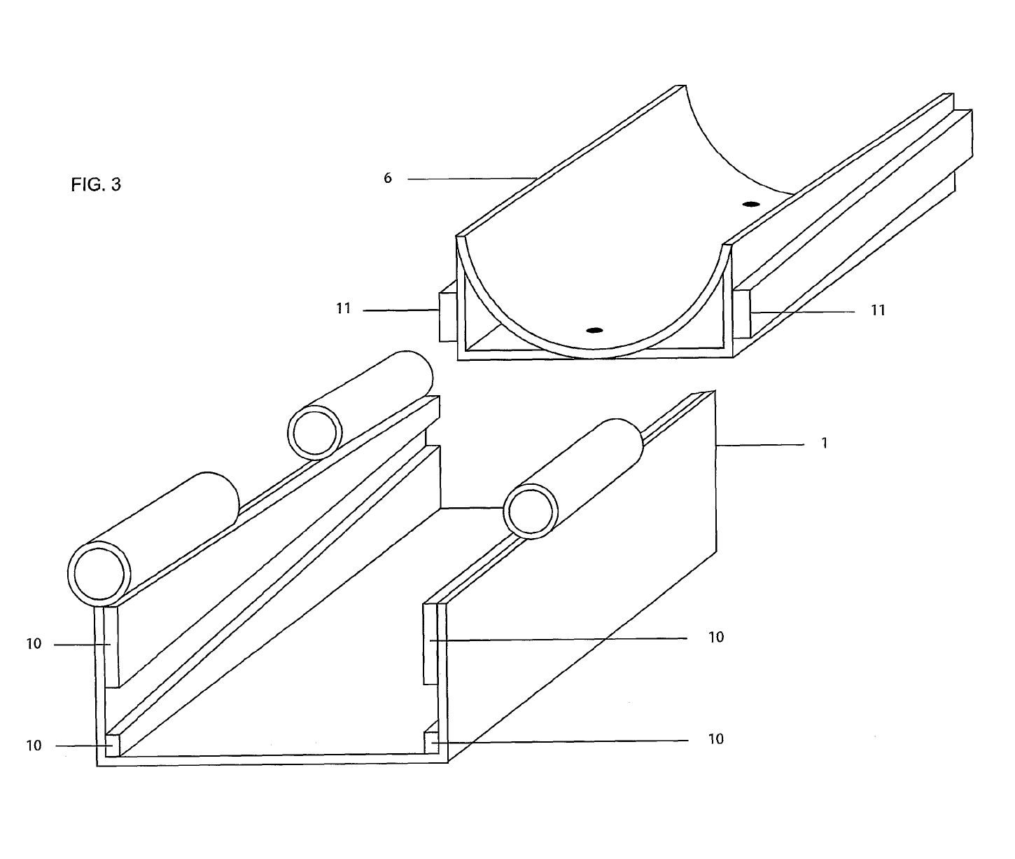

The clamp itself works by how the outer cases relate to the inner cases. As explained above, the bottom inner carriage sits stationary against the bottom casing whilst the top inner case moves longitudinally (with respect to the pathway for guiding or holding the pipe) inside the top casing along an angled guide structure formed from cooperating elements on the carriage and casing. This is achieved by four 10 mm thick nylon panels fixed in place inside the top outer casing. The panels have been cut and fixed to form two continuous inlets that slope at an identical angle to be used as casing guides on either side of the inner casing. This is illustrated by FIG. 3. Here you can see the outer top casing 1, without the top inner carriage 6 in place. The nylon casing guides 10 can be seen. To enable the top inner carriage 6 to make use of the casing guides 10, on the outside of the top inner carriage 6 are two fixed nylon blocks of the same thickness of 16 mm which act as carriage runners 11 to fit inside the casing guides 10. These runners are set at the exact same angle as the casing guides. When a pipe is in situ, by bringing the top inner carriage down it's casing guides, you are effectively making a clamp; by making a pulling movement on the pipe, this will cause a voluntary movement of the top carriage on it's casing guides which in turn will tighten the grip of the clamp to the pipe whilst all the time holding the pipe horizontal to the ground. By placing the guides and runners at the exact same angle this enables the top inner carriage to run parallel with the bottom inner carriage when in place.

To be able to get the full benefit of this clamp within the workplace, it has been designed to fit onto the arms of a small to large digger by the use of steel pivots welded on to the clamp (which are not shown), on the top outer casing 1. When attached to the digger arms using pins and reducing bushes, the clamp can then be placed within the ground where the pipe is intended to sit. Even when the clamp is attached to the digger it can still be separated into the top and bottom cases, allowing the user to lay the pipe in place, ready for the clamp to come together, encasing the pipe. The digger will then generate a backwards and forwards movement, causing the clamp to grip, subsequently followed by a release of the pipe and therefore feeding the pipe through as required. Nylon panels have been specifically used within the inside of the carriage for runners as well as the guides for safety reasons. The clamp will be initially used within the utility industries for the laying of pipes; by using nylon instead of a metal such as steel will eliminate the risk of possible sparks being caused through any friction made from the forward/backwards movement of the clamp.

What makes Ace's PC1 different to anything else in the market place currently is not only the unique clamping motion which enables the pipe to be clamped within a parallel motion but also the ease at which the clamp can be placed in situ. At the present time there are various other products available that will do the same job but not at the same ease as Ace's PC1. Also from a safety aspect, this pipe clamp is a far safer option due to the user being able to fit the clamp independently from the digger arm if needed. This invention is a lot smaller than anything else available; more adaptable with the attachments supplied and will enable the user to get the job done at a much quicker rate. This ultimately makes Aces PC1 a more financially viable option to any other product available, doing the same job at a slower pace.

1. A pipe clamp comprising a casing having top and bottom portions, and a pair of carriages, whereof the bottom carriage is fast with the bottom casing portion, and the top carriage is slidably engaged with lateral guides provided by the top casing portion, said guides sloping in parallel; and wherein the casing portions are hinged together so that the can pivot between an open configuration and a clamping configuration in which they embrace a pipe which is engageable by the carriages, wherein sliding of the top carriage in one direction reduces its spacing from the bottom carriage so as to tend to effect clamping of the pipe; while sliding in the opposite direction increases the spacing and thus tends to lessen or cease the damping.

2. (canceled)

3. A pipe clamp according to claim 1, including a plurality of pairs of attachments which are attachable to the inner carriages whereby they are adjustable in size to enable the clamp to grip pipes of different sizes.

4. A pipe clamp according to claim 3, wherein the attachments enable the clam, to be adapted to grip pipes of sizes 63 mm, 75 mm 90 mm and 110 mm.

5. A pipe clamp according to claim 1, in which the clamp has the means to be securely attached to the arms of a digger by the use of steel pivot points welded to the top of the clamp and held in place by the use of 2 pins and 4 bushes.

6. A pipe clamp according to claim 1, in which the top casing and the bottom casing can be separated from each other by the removal of two pins.

7. A pipe clamp according to claim 1, in which the top carriage us removable from the lateral guides.

8. A pipe clamp according to claim 1, in which the inner carriage has runners for engaging the guides, and both the runners and guides are made of nylon.
